(19) United States
(12) Patent Application Publication
(10) Pub. No.: US 2009/0077459 A1
(43) Pub. Date: Mar. 19, 2009

(54) Method And System For Presenting A Hotspot In A Hypervideo Stream

(76) Inventors: Robert P. Morris, Raleigh, NC (US); Robert J. Sundstrom, Cary, NC (US)

Correspondence Address: SCENERA RESEARCH, LLC, 111 CORNING RD., SUITE 220, CARY, NC, 27518, US

(21) Appl. No.: 11/857,767

(22) Filed: Sep. 19, 2007

(51) Int. Cl. G06F 15/00; G06F 3/00

(52) U.S. Cl. 715/201; 715/700

(57) ABSTRACT

Methods and systems are described for presenting a hotspot in a hypervideo stream comprising a plurality of video frames that are associated with at least one selectable hotspot. One method includes receiving, for presentation in a video presentation space, a first video frame including a first hotspot that is user selectable for initiating a first action, generating a second hotspot that is user selectable for initiating the first action, and generating a visual indication associating the first hotspot with the second hotspot. The method also includes presenting the second hotspot and the visual indication associating the first hotspot with the second hotspot with the received first video frame including the first hotspot.

### CROSS-REFERENCE TO RELATED APPLICATIONS

The present application is also related to co-pending U.S. patent application Ser. No. 11/769,280, entitled “METHOD AND SYSTEM FOR AUTOMATICALLY LINKING A CURSOR TO A HOTSPOT IN A HYPERVIDEO STREAM,” filed on Jun. 27, 2007, commonly owned with the present application, and incorporated here by reference in its entirety. In addition, the present application is also related to co-pending U.S. patent application Ser. No. 11/856,989 entitled “METHOD AND SYSTEM FOR AUTOMATICALLY ASSOCIATING A CURSOR WITH A HOTSPOT IN A HYPERVIDEO STREAM USING A VISUAL INDICATOR,” filed on Sep. 18, 2007, and commonly owned with the present application, and incorporated here by reference in its entirety.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Hypervideo is a displayed video stream that includes user selectable anchors, referred to as “hotspots,” that are linked to ancillary information. When a user views a hypervideo clip and selects the hotspot, the user can navigate from the video clip to the linked ancillary information. For example, a hotspot can be associated with an element in the video clip, such as a red automobile, and when selected, additional information about the automobile can be presented to the user, or a different video clip or a different segment of the same clip can be shown to the user.

In order to associate hotspots with elements in a hypervideo stream, it is necessary to track the position of the individual elements within the video clips used. Thus, when the exemplary red automobile is moving, the hypervideo media player system must be able to determine when the hotspot associated with the automobile has been selected, regardless of where it is on the screen when the selection is made. For video clips created artificially, e.g., by computer graphics, element tracking is relatively simple because the position of an element is specified on a coordinate system and that information can be then used to track the element. For video clips created from or based on live footage, however, element tracking is more complex. The video clip comprises a plurality of video frames, where each frame represents a still picture or “snapshot” of a particular moment in time. While each video frame contains visual information sufficient to permit the human brain to distinguish individual elements, such visual information does not generally enable a computer system to recognize the elements.

Nevertheless, several hypervideo authoring systems have been developed that support element tracking through the generation of hotspots that move with the element. FIGS. 1A, 1B and 1C illustrate three (3) exemplary video frames, 10A, 10B, and 10C, of a hypervideo stream that includes moving elements. In FIG. 1A, the first video frame 10A includes a first element, e.g., an automobile, that is associated with a first hotspot 12A. As is shown, the first hotspot 12A can be a defined region, referred to as an activation region, that can be similar in shape and size to the first element with which it is associated.

For the sake of clarity, the first hotspot 12A is represented by a rectangular box that generally encompasses the first element. In other instances, the defined region of a hotspot associated with an element is not displayed to the user. Rather, the appearance of a cursor 100, or any pointer indication, can change when the cursor 100 position is within the activation region of a hotspot. For example, when the cursor 100 is within a hotspot, the cursor 100 can appear as a pointing finger, otherwise the cursor 100 can appear as an arrow. Typically, when a viewer places the cursor 100 over the first element and selects the first element, the viewer effectively activates the associated first hotspot 12A. In this example, when the first hotspot 12A is activated, information 14A about the first element associated with the first hotspot 12A is presented.

In FIG. 1B, the second video frame 10b includes the first element and a second element, the rear automobile, that is also associated with a second hotspot 12b. As is shown, the first hotspot 12A is in a different location and has a different shape/size because the first hotspot 12A is tracking the location and shape/size of the first element. Generally, because the first element is “moving” away from the camera, its relative size is decreasing and thus, the size of the first hotspot 12A is also decreasing. As the size of the hotspot 12A decreases with each successive video frame (assuming the first element continues to travel away from the camera), it can be increasingly difficult for the viewer to place the cursor 100 on the first element to activate the associated first hotspot 12A. Thus, in FIG. 1C, while the viewer has placed the cursor 100 near the first element and selected what the viewer thinks is the first element, the cursor placement and selection actually has activated the second hotspot 12B, which is associated with the second element. As a result, information 14b about the second element associated with the second hotspot 12B is presented.

For some users, positioning the cursor 100 over a stationary graphical display element, such as an icon or hypertext link, can be difficult. In some instances, a user may exhibit diminished visual or physical abilities, or lack training and practice to correctly position the cursor 100. This difficulty is exacerbated in a hypervideo stream because elements captured in video clips, and their associated hotspots, are typically moving, and even if the element itself is physically stationary, the camera may be panning or zooming, thereby resulting in perceived movement.

Moreover, difficulties in positioning the cursor 100 properly can be attributable to the computer system itself. For example, a computer display can provide a high density presentation of material, rendering graphical display elements relatively small. Similarly, small computer displays, such as those for palm-held devices, may make graphical display elements difficult to select. In addition to user abilities and hardware limitations, the content displayed may include small elements, such as jewelry, with correspondingly small hotspots, making user selection with a pointing device difficult.

As illustrated above, inaccurate cursor positioning can result in mistakenly activating a hotspot associated with another element. With hypervideos, this mistake is particularly frustrating because the video stream continues for a specified time. To correct the mistake, the user must either replay the video clip or stop the presentation of the video clip and/or rewind it to some point. Moreover, the mistakenly activated hotspot can produce completely unintended results, which can be detrimental to the user. For example, in FIG. 1C, the viewer can mistakenly believe that he is reading information 14B about the front automobile, when in fact, the information 14B pertains to the rear automobile.

Accordingly, there exists a need for methods, systems, and computer program products for helping a user to track and activate a hotspot associated with an element in a hypervideo.

### SUMMARY

Methods and systems are described for presenting a hotspot in a hypervideo stream comprising a plurality of video frames that are associated with at least one selectable hotspot. One method includes receiving, for presentation in a video presentation space, a first video frame including a first hotspot that is user selectable for initiating a first action, generating a second hotspot that is user selectable for initiating the first action, and generating a visual indication associating the first hotspot with the second hotspot. The method also includes presenting the second hotspot and the visual indication associating the first hotspot with the second hotspot with the received first video frame including the first hotspot.

In another aspect of the subject matter disclosed herein, a system for presenting a hotspot in a hypervideo stream includes means for receiving, for presentation in a video presentation space, a first video frame including a first hotspot that is user selectable for initiating a first action, means for generating a second hotspot that is user selectable for initiating the first action and for generating a visual indication associating the first hotspot with the second hotspot, and means for presenting the second hotspot and the visual indication associating the first hotspot with the second hotspot with the received first video frame including the first hotspot.

In another aspect of the subject matter disclosed herein, a system for presenting a hotspot in a hypervideo stream includes a hypermedia player component configured for receiving, for presentation in a video presentation space, a first video frame including a first hotspot that is user selectable for initiating a first action, for generating a second hotspot that is user selectable for initiating the first action, and for generating a visual indication associating the first hotspot with the second hotspot, and a graphical user interface manager component for presenting the second hotspot and the visual indication associating the first hotspot with the second hotspot with the received first video frame including the first hotspot.

In another aspect of the subject matter disclosed herein, a computer readable medium containing a computer program, executable by a machine, for presenting a hotspot in a hypervideo stream includes executable instructions for receiving, for presentation in a video presentation space, a first video frame including a first hotspot that is user selectable for initiating a first action, for generating a second hotspot that is user selectable for initiating the first action, for generating a visual indication associating the first hotspot with the second hotspot, and for presenting the second hotspot and the visual indication associating the first hotspot with the second hotspot with the received first video frame including the first hotspot.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIGS. 1A-1C illustrate a plurality of video frames of an exemplary hypervideo stream including hotspots according to an exemplary embodiment;

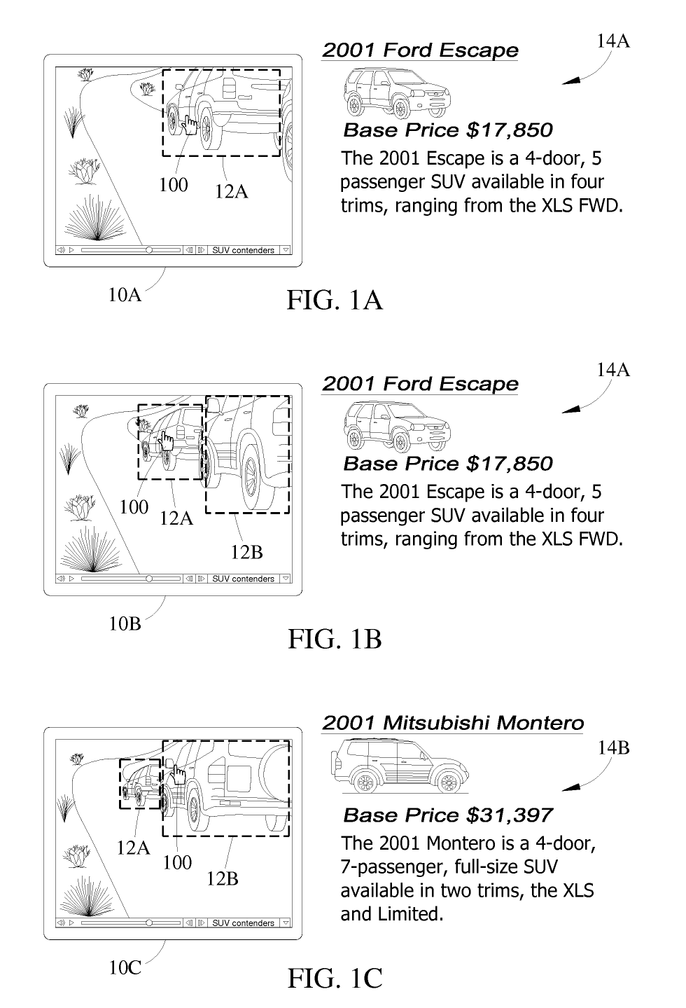

FIG. 2 is a block diagram illustrating a client device including an exemplary system for presenting a hotspot in a hypervideo stream according to an exemplary embodiment;

FIG. 3 is a flowchart illustrating a method for presenting a hotspot in a hypervideo stream according to an exemplary embodiment; and

FIGS. 4A-4C are exemplary display windows depicting hotspots according to exemplary embodiments.

### DETAILED DESCRIPTION

Methods, systems, and computer program products for presenting a hotspot in a hypervideo stream are disclosed. According to one embodiment, a hypervideo stream that includes a first selectable hotspot is received by a hypermedia player in a client device for presentation to a user in a video presentation space. For example, the video presentation space can be in a video media window rendered on a display either coupled to or integrated with the client device. The hypermedia player is configured to generate a second hotspot and a visual indication associating the second hotspot with the first hotspot. Herein the second hotspot will often be referred to as a “floating hotspot.” This is intended for ease of description and should not indicate that the second hotspot must “float,” The second hotspot can be of any size and shape and positioned anywhere inside or outside of the presentation space, even where referred to as a floating hotspot. The visual indication associating the floating hotspot with the first hotspot can be implemented in several ways. For example, the visual indication can be a visual connector such as a line or arc from the floating hotspot to the first hotspot. In another example, the visual indication can be an action such as changing a color, tint, or brightness of the first hotspot or adding a wireframe around the first hotspot when the user places a cursor into a region associated with the floating hotspot.

According to an exemplary embodiment, the floating hotspot associated with the first hotspot is logically, as well as visually, coupled to the first hotspot. That is, the action associated with the first hotspot is also associated with the floating hotspot such that the action can be initiated by activating the floating hotspot. In one embodiment, the floating hotspot can be relatively large and relatively stationary so that the user can easily select the floating hotspot, instead of the first hotspot, to initiate the desired action corresponding to the first hotspot. Moreover, the user has time to consider whether to activate the first hotspot without needing to manually track it while it moves. When a selection is made, the user can be assured that the action initiated corresponds to the intended hotspot.

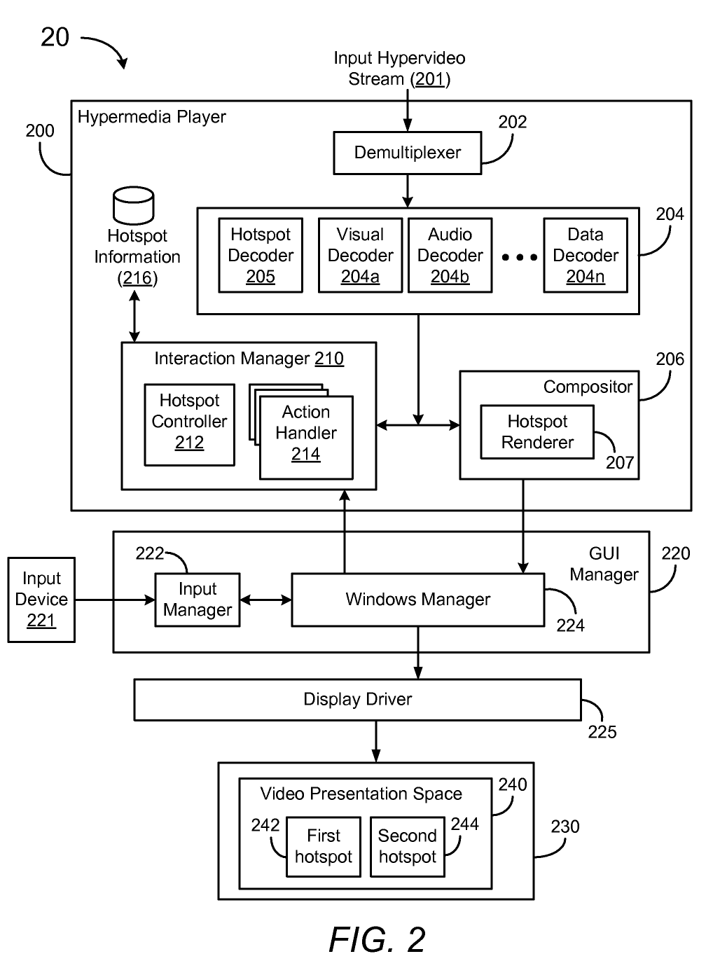

FIG. 2 is a block diagram illustrating a client device including an exemplary system for presenting a hotspot in a presentation of a hypervideo stream according to an exemplary embodiment. In one embodiment, the device 20 includes a hypermedia player 200, a GUI manager component 220, and a display 230 that includes a video presentation space 240. In one embodiment, the hypermedia player 200 can be an MPEG-4 media player, as described at “http://www.chiariglione.org/mpeg/standards/mpeg-4/mpeg-4.htm” (“Overview of the MPEG-4 Standard,” Apr. 19, 2007). In this embodiment, the media player 200 includes a demultiplexer 202, a decoder 204, comprising a set of data-specific decoder components 204a, 204b, 204n, 205, and a compositor 206.

As stated above, an input hypervideo stream 201 comprises a plurality of video frames. One or more of the plurality of video frames can be associated with hotspot information corresponding to a hotspot. In one embodiment, the hotspot information can include: action information indicating an action to be initiated in response to a user input, such as launching a particular URL when the hotspot is selected; hover information to be displayed when the cursor hovers over the hotspot for a predetermined time period; location information that defines where an activation region associated with the hotspot is located in the video frame; visual information, such as an icon that can be used to represent the hotspot, and/or three-dimensional information that indicates in which spatial plane the hotspot is located in relation to other hotspots.

In one embodiment, at least a portion of the hotspot information can be provided by a sender or a source of the hypervideo stream. For example, a car manufacturer can create the hypervideo stream 201 and add hotspot information corresponding to the cars in the hypervideo stream 201. In one embodiment, the hotspot information can be included in each frame as video data. For example, the hotspot can be indicated by a visual indication, such as a colored box or other shape enclosing the hotspot when presented. Video data indicating a hotspot can also be non-visible such as a transparent icon, shape, and/or other marker.

In another embodiment, the hotspot can be indicated by metadata included in one or more of the associated video frames. The metadata can be included in the frame or in a separate metadata stream of the hypervideo stream 201, for example, as support by the MPEG 4 standard. In one example, the metadata can be a marker in an audio stream included in and/or associated with the hypervideo stream 201. Various synchronization techniques can be used to associate metadata with the hotspot in a frame and/or the metadata can include information identifying at least a portion of the video portion of a frame associated with the hotspot. In another embodiment, a combination of visual data and metadata data can be used to convey the hotspot information.

Alternatively or in addition, a portion of the hotspot information can be provided by the receiving client device 20 and/or the viewing user. For example, the client device 20 and/or user can provide action information that indicates what action should be initiated in response to a particular input command, e.g., a right-mouse click on the hotspot can initiate an action that identifies the source of the hypervideo stream 201.

In one embodiment, the hypervideo stream 201 includes a plurality of data streams, including for example, a video data stream, an audio data stream and a metadata data stream. During transmission and/or storage, the plurality of data streams are typically encoded, e.g., compressed, and multiplexed to improve transmission efficiencies and/or to reduce storage requirements. Thus, when the input hypervideo stream 201 is received by the hypermedia player 200, the demultiplexer 202 reconstructs each separate data stream in the hypervideo stream 201. Each reconstructed data stream is then provided to a decoder 204a, 204b, 204n, 205 compatible with the format of the data stream.

Each encoded data stream is received and processed by a data decoder component 204a, 204b, 204n, 205 compatible with the format of the data stream. For example, an MPEG encoded video data stream is received and decoded by a video data decoder 204a, an MPEG encoded audio data stream is received and decoded by an audio data decoder 204b, and the MPEG encoded metadata stream is received and decoded by the hotspot decoder component 205.

In one embodiment, the hotspot decoder component 205 can detect the hotspot information in the video frame of the plurality of video frames in the hypervideo stream 201, and can be dedicated to decoding the metadata stream encoded, for example, in an XML language specified by a schema. Metadata in a metadata stream can be associated with a presentable video frame using various methods including adding frame information to the metadata to associate metadata with a particular video frame. Alternately, various synchronization techniques can be used. For example, the metadata stream can be formatted in frames that are synchronized with video frames based on time data. Thus, hotspot information detected by the hotspot decoder component 205 can be associated with the corresponding hotspot in a visual portion of a video frame.

The decoded data streams and scene description information are received by the compositor 206, which presents the data in a unified manner. This can include synchronizing data from the plurality of streams for coordinated presentation including, for example, construction of an image (or audio) from more than one stream requiring drawing of objects from each stream in a correct order and position with respect to other objects. In one embodiment, the compositor 206 interoperates with a windows manager 224 in the GUI manager component 220 to present a visual representation of the video frame, optionally including a visual representation of the hotspot in the video presentation space 240 presented on the display 230. For example, the windows manager 224, in an embodiment, can direct a display driver 225 to provide data written to one or more display buffers (not shown) to the display 230 for presentation.

Once the hotspot, e.g., first hotspot 242, is presented in the video presentation space 240, an action associated with the hotspot 242 can be initiated in response to a user input and/or other triggering event. In one embodiment, several actions can be initiated depending on the triggering event. For instance, a first action can be initiated in response to a first triggering event, e.g., a left-click mouse input, and a second action can be initiated in response another triggering event, e.g., a right-click mouse input. In one embodiment, an action associated with the hotspot 242 can be managed by an action handler component 214, which is configured to respond to an associated triggering event, e.g., an input indicating the hotspot 242 has been selected. The action handler 214 performs and/or provides for performing the action associated with the triggering event.

As mentioned above, the hotspot information, which includes the action information, can be provided in a metadata stream, and/or provided by a source other than the source of the hypervideo stream 201. For example, the hypermedia player 200 can be configured to perform an action based on an attribute of the hotspot, such as its source and/or type, and/or perform an action based on a condition independent of the video frame and the hypervideo stream 201, such as a user ID or time related attribute. Events other than the selection of hotspots can be detected and the hypermedia player 200 can be configured to perform an action associated with the hotspot. For example, a specified input can be associated with an action handler 214 that creates a bookmark for all resources associated with hotspots in a hypervideo stream 201.

As indicated, an action handler 214 can be invoked as the result of the hypermedia player 200 detecting a triggering event. The event can be an input event detected by an input device 221, e.g., a mouse, a keyboard, a four-way controller, and/or a phone key. The input device 221 can provide input data corresponding to a triggering event to an input manager 222. The windows manager 224 can receive the input data from the input manager 222 and associate the received input data with, for example, a user interface component such as the hotspot 242. The windows manager 224 can then route the received input data to the particular one or more action handler components 214 associated with the corresponding triggering event so that the associated action can be initiated.

Because action handlers 214 are extensible, there are no limits to what actions can be performed by an action handler 214 when a triggering event is detected. The action may affect the playing of the hypervideo stream 201, for example, by stopping or pausing it, changing the playback speed and/or direction, or jumping to another location in the stream 201. The action may cause new information to be displayed from other media sources. This new information may be composed with the video stream 201, may be displayed in another area of the video presentation space 240, or may be inserted into the video stream 201. The presentation of the new information may be immediate or deferred, for example, until the end of the video or until the user pauses or stops the video. The action could also include acts that do not affect the video stream or the presentation of other media streams or information. For example, the action could initiate the purchase of an item, send an email, add an entry to a task list, or trigger an agent. The action may be immediate or it may be queued or deferred until some later time, such as the end of the video or a time of day. The initiation of the action may also require subsequent, follow-on events such as a confirmation from the user.

Clearly, the advantages and benefits provided by hotspots are vast and limited only by a developer's imagination. Nevertheless, many of these advantages are difficult to realize because many triggering events require the user to track the hotspot 242 with the input device 221, e.g., mouse, and/or to perform an action, e.g., left-click mouse action, on the hotspot 242. For numerous reasons, tracking the hotspot 242 with the input device 221 can be difficult and neither the input device 221 nor the input manager 222 can provide assistance to the user who is attempting to track a moving hotspot 242 in a video clip.

According to an exemplary embodiment, the hypermedia player 200 includes an interaction manager component 210 configured for managing user interaction with hotspots in the received and presented hypervideo stream 201. In one embodiment, the interaction manager component 210 is configured to receive the decoded hotspot information from the hotspot decoder component 205, to generate a floating hotspot for the hotspot, and to generate a visual indication associating the floating hotspot with the hotspot corresponding to the hotspot information. In one embodiment, the floating hotspot and visual indication are passed to a hotspot renderer 207 in the compositor 206 so that the floating hotspot and visual indication can be properly composed with the corresponding hotspot and presented in the video presentation space 240.

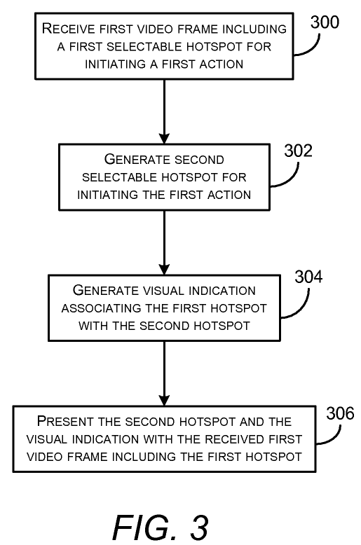

FIG. 3 is a flowchart illustrating an exemplary method for presenting a hotspot in a hypervideo stream according to one embodiment. Referring to FIG. 2 and FIG. 3, the exemplary process begins when the hypermedia player 200 receives, for presentation in the video presentation space 240, a first video frame including a first hotspot that is user selectable for initiating a first action (block 300). According to an exemplary embodiment, the hypermedia player 200 includes means for receiving the first video frame. For example, the demultiplexer 202 in the hypermedia player 200 can be configured to perform this function.

In one embodiment, the demuliplexer 202, as stated above, separates the hypervideo stream of the first video frame into a plurality of encoded data streams including data streams for hotspot information corresponding to one or more selectable hotspots, including the first hotspot. The hotspot information for the hotspot is detected and decoded by the hotspot decoder component 205, which then passes the decoded hotspot information to the hotspot renderer 207 in the compositor 206. The hotspot renderer 207 composes the first hotspot with the other decoded data streams and renders the video frame to the user.

According to an exemplary embodiment, the decoded hotspot information is also passed to the interaction manager component 210, which manages and stores the hotspot information for the hypervideo stream 201 in a data store 216. When the decoded hotspot information is received, a second hotspot, e.g., a floating hotspot, that is user selectable for initiating the first action associated with the first hotspot is generated (block 302). According to an exemplary embodiment, the hypermedia player 200 includes means for generating the second hotspot. For example, a hotspot controller component 212 in the interaction manager component 210 can be configured to perform this function.

In one embodiment, the hotspot controller component 212 associates the first hotspot information with second hotspot information corresponding to the second hotspot. Similar to the first hotspot information, the second hotspot information can include location information indicating where the second hotspot is located and visual information associated with the second hotspot. In addition, the second hotspot information includes linking information corresponding to a visual indication associating the second hotspot with the first hotspot.

According to an exemplary embodiment, the association between the first hotspot information and the second hotspot information can be bi-directional or unidirectional. The association can be implemented by providing information allowing the first hotspot information to be identified from the second hotspot information, such information can include an identifier of the first hotspot information and/or a location of the first hotspot 242 in the video frame.

Based on the association, the second hotspot is selectable for initiating the action associated with the first hotspot performed by the corresponding action handler 214. In one embodiment, additional action handlers 214 can be associated with the second hotspot for responding to other triggering events. The action handlers 214 can be the same action handlers 214 associated with each respective event to which the first hotspot is responsive and/or the action handlers 214 can perform actions different from the action handlers 214 associated with the first hotspot with respect to any particular event.

In one embodiment, the hotspot controller component 212 generates at least a portion of the second hotspot information based on requirements defined by the hypermedia player 200 and/or a viewer. In other embodiments, at least a portion of the second hotspot information can be based on requirements defined by a sender and/or an originator of the hypervideo stream 201. In this embodiment, the second hotspot information could be added as metadata along with the first hotspot information or incorporated into the video and/or audio data, as described above with respect to the first hotspot information.

According to an exemplary embodiment, when the second hotspot is generated, a visual indication associating the first hotspot with the second hotspot is also generated (block 304). In one embodiment, the hypermedia player 200 includes means for generating the visual indication. For example, the hotspot controller component 212 in the interaction manager component 210 can be configured to perform this function as well.

In one embodiment, the hotspot controller component 212 processes the linking information corresponding to a visual indication included in the second hotspot information. For example, the linking information can direct the hotspot controller component 212 to determine an edge, a center, a center of gravity or a visual center of the first hotspot and to generate a connector from the second hotspot to the edge, center, center of gravity or visual center of the first hotspot.

Referring again to FIG. 3, the second hotspot and the visual indication associating the first hotspot with the second hotspot are presented with the first video frame including the first hotspot (block 306). According to an exemplary embodiment, the hypermedia player 200 includes means for presenting the second hotspot and the visual indication with the first video frame. For example, the windows manager 224 in the GUI manager component 220 can be configured to perform this function.

In one embodiment, after the hotspot controller component 212 generates the second hotspot and the visual indication associating the first hotspot with the second hotspot, the hotspot controller component 212 can pass the second hotspot information and the visual indication to the hotspot renderer 207 in the compositor 206. The hotspot renderer 207 and the compositor 206 interoperate with the windows manager 224 in the GUI manager component 220 to present the visual representation of the video frame including a visual representation of the second hotspot 244 and the visual indication associating the first hotspot 242 with the second hotspot 244, and optionally including a visual representation of the first hotspot 242 in the video presentation space 240 presented on the display 230.

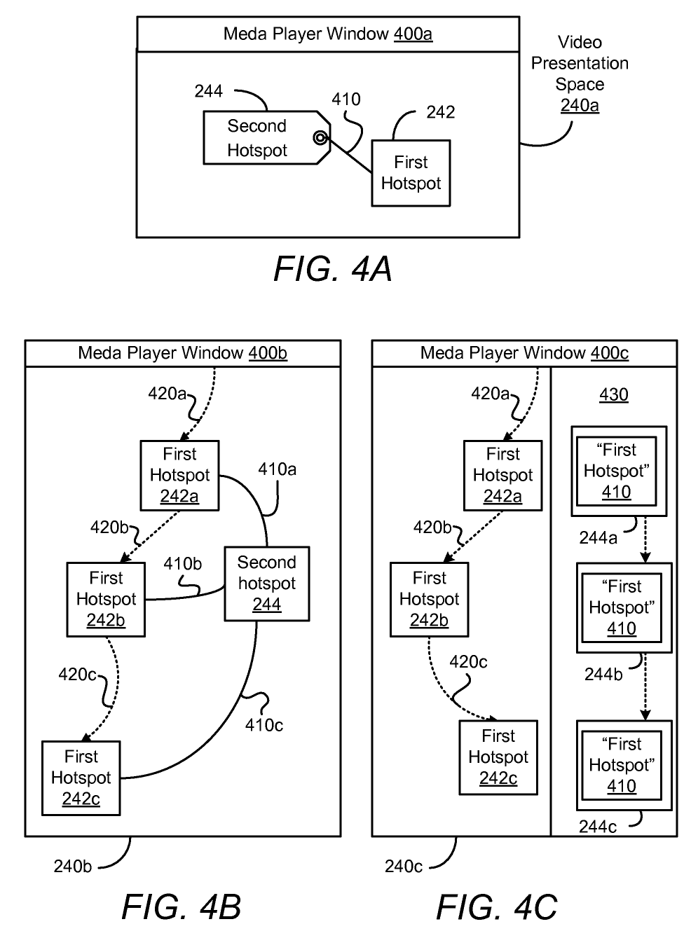

The second hotspot 244 and the visual indication associating the first hotspot 242 with the second hotspot 244 can be presented in a variety of ways. For example, FIGS. 4A, 4B and 4C depict exemplary media player windows 400a, 400b, 400c that include video presentation spaces 240a, 240b, 240c in which one or more video frames are presented. In each presentation space 240a-240c, the first hotspot 242 is associated with a moving element, e.g., a car, in the presented video frame. The first hotspot 242 can be visible as a hotspot or not visible, and its size, shape and location can change from frame to frame, and may even change during the presentation of a particular frame.

According to one embodiment, shown in FIG. 4A, the second hotspot 244 can be visually presented as a tag, e.g., a label or price tag, and the visual indication 410 can be depicted as a connector attaching, and thus visually associating, the second hotspot 244 and the first hotspot 242. Although the visual indication 410 is depicted as a straight line, any sort of indication is contemplated. For example, any type of connector can be used, including curved lines, lines that connect the two hotspots 242, 244 and lines that don't connect the two hotspots 242, 244. A color can be used as a visual indication associating the first hotspot 242 and the second hotspot 244. For example, the color of the first hotspot 242 and the second hotspot 244 can be the same or complimentary. Color can be used with a connector such as a line or with no connector. Any display attribute or combination of attributes can be used to provide the visual indication for associating the second hotspot 244 and the first hotspot 242.

According to one embodiment, the visual indication 410 can be presented constantly, periodically, and/or in response to a user's input. For example, in one embodiment, the visual indication 410 can be presented when a cursor is placed in the second hotspot 244. In this case, the visual indication 410 can be a wireframe border outlining the first hotspot 242 associated with the second hotspot 244. Alternatively, or in addition, the brightness, tint and/or color of the first hotspot 242 can be altered when the cursor is placed in the second hotspot 244.

In another embodiment, shown in FIG. 4B, the first hotspot 242a-242c is depicted as moving as video frames associated with the first hotspot 242 are presented in the video presentation space 240b. A possible path of the first hotspot 242a-242c is illustrated by the path 420a-420c indicated by the dotted lines. In one embodiment, the second hotspot 244 can be visually presented in a location different from a current location of the first hotspot 242a-242c, and the second hotspot 244 can be presented in any size and/or shape. The visual indication 410a-410c, presented as a curved line connecting the first hotspot with the second hotspot, can also move and change according to the movement of the first hotspot 242a-242c.

In one embodiment, the second hotspot 244 can be presented as stationary with respect to the first hotspot 242a-242c in the video presentation space 240b. Alternatively, in another embodiment, the second hotspot 244 can move, however, its movement, location, and size can be such that tracking the second hotspot 244 is easier than tracking the first hotspot 242a-242c. Movement of the second hotspot 244 can be based on, for example, movement of the first hotspot 242a-242c, a location of another object in the video presentation space 240b, and/or any other attribute of the first hotspot 242a-242c or video presentation space 240b and its contents.

According to another embodiment, shown in FIG. 4C, the second hotspot 244a-244c is displayed in a region 430 outside of the video presentation space 240c. In one embodiment, the region 430 can be reserved for second hotspots 244a-244c, and while depicted as a vertical section, the region 430 can border the presentation space 240c horizontally as well.

In this exemplary embodiment, the first hotspot 242a-242c moves as video frames associated with the first hotspot are presented in the video presentation space 240c. As is shown, the second hotspot 244a-244c can move within the region 430 in a manner corresponding to movement of the first hotspot 242a-242c. For example, the second hotspot 244a-244c can be presented so that it is aligned horizontally and/or vertically with the associated first hotspot 242a-242c. In another embodiment, the second hotspot 244a-244c can have more than one simultaneous visual representation. For example, a second representation of the second hotspot (not shown) can be displayed in an area reserved along a top and/or bottom portion of the video presentation area 240c. The two representations of the second hotspot can be moved so that lines connecting the two representations of the second hotspot with the first hotspot 242a-242c intersect in the first hotspot 242a-242c.

In FIG. 4C, the visual indication 410 associating the second hotspot, e.g., 244a, with the first hotspot 242a can be a label corresponding to the first hotspot 242a. Alternatively, or in addition, graphics, images, and streaming media can be presented as visual indications of the association between the first hotspot 242a and the second hotspot 244a.

According to an exemplary embodiment, the second hotspot 244 can be presented prior to the presentation of the video frame and the first hotspot 242, thereby allowing the user to receive advanced notice of the appearance of the first hotspot 242. Similarly, the second hotspot 244 can be presented in frames after the presentation of the video frame including the first hotspot 242 where the subsequent frames do not include the first hotspot 242. For example, the hypermedia player 200 can receive a second video frame that temporally precedes or follows the first video frame and that does not include the first hotspot 242, and present the second hotspot 244 with the second video frame. Various indicators can be presented indicating a time until and/or a time after the first hotspot 242 is/was presented. For example, the second hotspot 244 and/or the visual indication can be presented with an attribute, such as a transparency level and/or color saturation, that is correlated to a time until and/or a time since the first hotspot is or was associated with a presented video frame.

According to an exemplary embodiment, an input associated with the second hotspot 244 initiates an action corresponding to that action to be initiated in response to the same input received in association with the first hotspot 242. For example, in one embodiment, when the second hotspot 244 and/or the visual indication 410 is selected, the action associated with selecting the first hotspot 242 is initiated. Alternatively, or in addition, when the cursor position is in the second hotspot 244 for a first predetermined time period and neither the first hotspot 242 nor the second hotspot 244 have been activated, i.e., selected, the hover information of the first hotspot 242 can be provided to the user. In this manner, the user can easily view the hover information without worrying about manually tracking the first hotspot 242.

In another embodiment, other actions can be associated with input events associated the second hotspot 244 such that the appearance and/or movement of the first hotspot 242 can be affected in response to an action performed using the second hotspot 244. For example, the movement of the first hotspot 242 can be accelerated or decelerated by dragging the second hotspot 244 up or down, respectively. In another example, the presentation of the first hotspot 242 can be halted in response to a “double-click” input event associated with the second hotspot 244.

In some instances, the first hotspot 242 is not associated with subsequently received video frames. For example, when the element associated with the first hotspot 242 disappears from the video clip because the camera pans away from the element, the subsequent video frames will not be associated with the first hotspot 242. In this case, the second hotspot 244 can be presented, in one embodiment, for a second predetermined time period even when the first hotspot 242 is not associated with subsequently received video frames. Because the second hotspot 244 lingers, the user can still activate the second hotspot 244 within the second predetermined time period to initiate the action associated with the first hotspot 242 even when the element and the first hotspot 242 are no longer presented to the user.

Although embodiments have been described using a hypermedia player 200 configured for MPEG-4 encoded video streams, other video stream encodings and media players can be used, such as Quicktime® or Flash®. For example, QuickTime® offers support for sprites, which are object-based animations in a layer that is separate from, but synchronized with, the video layer. In MPEG-4 terminology, a sprite is a media object separate from the video media object. The sprite animations can be included in the user presentation, or not, by setting of a visibility flag. Wired sprites are sprites that react to user interaction and respond to user events such as mouse-over (hover) and mouse-down (selection). Wired sprites are aware of their own boundaries and track when the user is potentially interacting with them. They also keep track of which actions to perform for which user events. Flash® supports interactivity with ActionScripts, which handle animations and mouse events such as selection.

Through aspects of the embodiments described, a second hotspot 244 is generated and associated, logically and visually, with a first hotspot 242. Accordingly, an action associated with the first hotspot 242 is also associated with the second hotspot 244 such that the action can be initiated by activating the second hotspot 244.

In one embodiment, the second hotspot 244 can be relatively large and relatively stationary so that the user can easily select the second hotspot 244, instead of the first hotspot 242, to initiate the desired action corresponding to the first hotspot 242. Moreover, the user has time to consider whether to activate the first hotspot 242 without needing to manually track it while it moves. When a selection is made, the user can be assured that the action initiated corresponds to the intended hotspot 242.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for presenting a hotspot in a hypervideo stream, wherein the hypervideo stream comprises a plurality of video frames that are associated with at least one user selectable hotspot, the method comprising:
receiving, for presentation in a video presentation space, a first video frame including a first hotspot that is user selectable for initiating a first action;
generating a second hotspot that is user selectable for initiating the first action;
generating a visual indication associating the first hotspot with the second hotspot; and
presenting the second hotspot and the visual indication associating the first hotspot with the second hotspot with the received first video frame including the first hotspot.

2. The method of claim 1 wherein receiving the first video frame includes detecting first hotspot information corresponding to the first hotspot, wherein the first hotspot information comprises location information indicating where the first hotspot is located in the video frame, and at least one of action information indicating the first action to be performed when the first hotspot is activated, hover information to be provided when a cursor is positioned within the first hotspot for a first predetermined time period, and visual information associated with the first hotspot.

3. The method of claim 2 further comprising associating the first hotspot information with second hotspot information corresponding to the second hotspot, wherein the second hotspot information comprises at least one of location information indicating where the second hotspot is located, visual information associated with the second hotspot, and linking information corresponding to the visual indication associating the second hotspot with the first hotspot.

4. The method of claim 3 wherein the second hotspot information corresponding to the second hotspot is defined by at least one of a sender of the first video frame, an originator of the first video frame, a device receiving the first video frame, and a viewer of the first video frame.

5. The method of claim 2 including:
providing the hover information of the first hotspot information corresponding to the first hotspot when a cursor position is in the second hotspot associated with the first hotspot for the first predetermined time period and neither the second hotspot nor the first hotspot has been activated.

6. The method of claim 1 including:
receiving, for presentation in the video presentation space, a second video frame that does not include the first hotspot, wherein the second video frame is one of received before the first video frame and received after the first video frame; and
presenting the second hotspot with the received second video frame.

7. The method of claim 1 including initiating the first action when at least one of the second hotspot, the visual indication, and the first hotspot is selected.

8. The method of claim 1 wherein generating the visual indication includes determining one of a closest edge, a center, a center of gravity, and a visual center of the first hotspot, and generating a connector from the second hotspot to one of the determined closest edge, center, center of gravity, and visual center of the first hotspot.

9. The method of claim 1 wherein presenting the visual indication includes at least one of presenting a wireframe border outlining the first hotspot, and altering one of a brightness, tint and color of the first video frame in the first hotspot, and wherein the visual indication is presented at least one of constantly, periodically, or in response to user input.

10. The method of claim 9 wherein prior to presenting the visual indication, the method includes determining that a position of a cursor is in the second hotspot.

11. The method of claim 1 wherein presenting the second hotspot includes at least one of displaying the second hotspot in the video presentation space and displaying at least a portion of the second hotspot in a region outside of the video presentation space, and wherein a second location of the second hotspot is based on a first location of the first hotspot in the first video frame.

12. The method of claim 1 including affecting at least one of an appearance and movement of the first hotspot in response to an action performed using the second hotspot.

13. A system for presenting a hotspot in a hypervideo stream, wherein the hypervideo stream comprises a plurality of video frames that are associated with at least one user selectable hotspot, the system comprising:
means for receiving, for presentation in a video presentation space, a first video frame including a first hotspot that is user selectable for initiating a first action;
means for generating a second hotspot that is user selectable for initiating the first action and for generating a visual indication associating the first hotspot with the second hotspot; and
means for presenting the second hotspot and the visual indication associating the first hotspot with the second hotspot with the received first video frame including the first hotspot.

14. A system for presenting a hotspot in a hypervideo stream, wherein the hypervideo stream comprises a plurality of video frames that are associated with at least one user selectable hotspot, the system comprising:
a hypermedia player component configured for receiving, for presentation in a video presentation space, a first video frame including a first hotspot that is user selectable for initiating a first action, for generating a second hotspot that is user selectable for initiating the first action, and for generating a visual indication associating the first hotspot with the second hotspot; and
a graphical user interface manager component configured for presenting the second hotspot and the visual indication associating the first hotspot with the second hotspot with the received first video frame including the first hotspot.

15. The system of claim 14 wherein the hypermedia player component includes:
a decoder component configured for detecting first hotspot information corresponding to the first hotspot, wherein the first hotspot information comprises location information indicating where the first hotspot is located in the video frame, and at least one of action information indicating the first action to be performed when the first hotspot is activated, hover information to be provided when the cursor is positioned substantially within the first hotspot for a first predetermined time period, and visual information associated with the first hotspot.

16. The system of claim 15 wherein the hypermedia player component includes a hotspot controller component for associating the first hotspot information with second hotspot information corresponding to the second hotspot, wherein the second hotspot information comprises at least one of location information indicating where the second hotspot is located, visual information associated with the second hotspot, and linking information corresponding to the visual indication associating the second hotspot with the first hotspot.

17. The system of claim 16 wherein the second hotspot information corresponding to the second hotspot is defined by at least one of a sender of the first video frame, an originator of the first video frame, a device receiving the first video frame, and a viewer of the first video frame.

18. The system of claim 15 wherein the hypermedia player component includes an action handler component for providing the hover information of the first hotspot information corresponding to the first hotspot when a cursor position is in the second hotspot associated with the first hotspot for the first predetermined time period and neither the second hotspot nor the first hotspot has been activated.

19. The system of claim 18 wherein the action handler component is configured for initiating the first action when at least one of the second hotspot, the visual indication, and the first hotspot is selected.

20. The system of claim 14 wherein the hypermedia player component is configured for receiving, for presentation in the video presentation space, a second video frame that does not include the first hotspot, wherein the second video frame is one of received before the first video frame and received after the first video frame, and the graphical user interface manager component is configured for presenting the second hotspot with the received second video frame.

21. The system of claim 14 wherein the hypermedia player component is configured for determining one of a closest edge, a center, a center of gravity, and a visual center of the first hotspot, and generating a connector from the second hotspot to one of the determined closest edge, center, center of gravity, and visual center of the first hotspot.

22. The system of claim 14 wherein the graphical user interface manager component is configured for at least one of presenting a wireframe border outlining the first hotspot, and altering one of a brightness, tint and color of the first video frame in the first hotspot, and wherein the visual indication is presented at least one of constantly, periodically, or in response to user input.

23. The system of claim 14 wherein the graphical user interface manager component is configured for at least one of displaying the second hotspot in the video presentation space and displaying at least a portion of the second hotspot in a region outside of the video presentation space, and wherein a second location of the second hotspot is based on a first location of the first hotspot in the first video frame.

24. The system of claim 14 wherein at least one of an appearance and movement of the first hotspot is affected in response to an action performed using the second hotspot.

25. A computer readable medium containing a computer program, executable by a machine, for presenting a hotspot in a hypervideo stream, wherein the hypervideo stream comprises a plurality of video frames that are associated with at least one user selectable hotspot, the computer program comprising executable instructions for:
receiving, for presentation in a video presentation space, a first video frame including a first hotspot that is user selectable for initiating a first action;
generating a second hotspot that is user selectable for initiating the first action;
generating a visual indication associating the first hotspot with the second hotspot; and
presenting the second hotspot and the visual indication associating the first hotspot with the second hotspot with the received first video frame including the first hotspot.
